(19) United States
(12) Patent Application Publication
(10) Pub. No.: US 2005/0044097 A1
(43) Pub. Date: Feb. 24, 2005

(54) Method and apparatus for facilitating data stewardship for metadata in an ETL and data warehouse system

(76) Inventors: Jaime Singson, Cambridge, MA (US); Xiaohua Chen, Palo Alto, CA (US)

Correspondence Address: PARK, VAUGHAN & FLEMING LLP, 508 SECOND STREET, SUITE 201, DAVIS, CA, 95616, US

(21) Appl. No.: 10/644,318

(22) Filed: Aug. 19, 2003

(51) Int. Cl. G06F 17/00

(52) U.S. Cl. 707/102

(57) ABSTRACT

One embodiment of the present invention provides a system that facilitates data stewardship in for metadata in a data warehouse system. The system operates by first allowing a user to create metadata for the database system. Next, the system allows a super user to create a plurality of collections for a list of subject areas. Finally, the system allows a super user to move the metadata into and out of a collection. The super user then assigns a data steward for the collection, wherein the data steward is allowed to manipulate the metadata in the collection.

### BACKGROUND

1. Field of the Invention

The present invention relates to techniques for providing security in a database system. More specifically, the present invention relates to a method and an apparatus for facilitating data stewardship for metadata in a database system.

2. Related Art

Modern database systems include a class of data called metadata. Metadata is the data used by the database system to describe the various files, tables, attributes, and procedures that relate to the database. Metadata is essentially “data about data.”

Database designers undertaking the responsibility of fashioning an enterprise's metadata architecture will occasionally overlook important considerations, such as metadata security and quality in preference to more pressing issues. Understandably, designing the overall structure of an enterprise's data warehouses and marts, locating the diverse metadata origins, and understanding their structured, and occasionally unstructured, representations often takes precedence over metadata security and quality.

A data warehouse is a storage location where a collection of diverse data is collected, stored, and summarized. This data includes a set of tools for analyzing, integrating, querying, and reporting data on behalf of a user.

Metadata in an extract, transform, and load (ETL system is the data used by the ETL system to describe: the location and structure of data sources, such as flat files, database tables, views, etc.; the location and structure of data analysis, such as dimensions, cubes, etc.; and the tools, such as database procedures used for data gathering, integrating, querying, and reporting. Metadata is essentially “data about data.” This metadata is used to build and populate the data warehouse.

Many metadata management designers regard questions of metadata security and data stewardship essential in the initial design of their metadata repository. They propose that these types of issues are indeed critical, and should be taken into consideration well before the metadata project is nearing “completion,” and certainly not as an afterthought. A fully constructed, detailed, and accurate, but insecure metadata repository is a dangerous roadmap to an enterprise that can easily be exploited and manipulated by a malicious user or hacker. Even within a trusted organization, users within different areas of the organization could accidentally and unsuspectingly compromise the quality of metadata defined by a colleague. This is the risk of being too permissive with an enterprise's metadata designs. These sorts of errors may provide faulty information to people making critical business decisions and may also go undetected for prolonged periods of time.

Typically, when metadata is defined, there is little or no consideration about securing the consistency or safety of the metadata. At present, security for metadata is administered on an instance-by-instance basis. For example, a user (or administrator) who creates a definition of a table can also specify permissions for this metadata. This has led enterprises to strongly consider the value of a strong metadata tool that secures this metadata from careless errors, potential hackers, and/or malicious users.

Allowing individual users to specify the permissions for metadata results in an uncoordinated security system, possibly with many inconsistencies and errors. On the other hand, requiring an administrator to specify the permissions for metadata, while very flexible and very secure (if the administrator is trusted), can create a bottleneck in the system, which causes the system not to scale.

Hence, what is needed is a method and an apparatus for providing security for metadata within a database without the problems described above.

### SUMMARY

One embodiment of the present invention provides a system that facilitates data stewardship in for metadata in a data warehouse system. The system operates by first allowing a user to create metadata for the database system. Next, the system allows a super user to create a plurality of collections for a list of subject areas. Finally, the system allows a super user to move the metadata into and out of a collection. The super user then assigns a data steward for the collection, wherein the data steward is allowed to manipulate the metadata in the collection.

In a variation of this embodiment, a collection administrator is allowed to move metadata into the collection.

In a further variation, the data steward includes more than one individual.

In a further variation, manipulating the metadata includes editing and deleting the metadata.

In a further variation, the collection is related to a specified subject area.

In a further variation, the data steward can be a data steward for more than one collection.

In a further variation, the super user has access to the metadata within a plurality of collections.

In a further variation, the metadata can include data descriptions.

In a further variation, the metadata can include procedures related to a database system.

In a further variation, a user is allowed to create new metadata and to request that the new metadata be moved to the collection.

In a further variation, a user is allowed to manipulate metadata that the user owns and that does not belong to a collection.

In a further variation, the data steward is allowed to create metadata within a folder in the collection which automatically causes the metadata to be added to the collection. Automatically adding the metadata eases the administration of the collection.

In a further variation, only the super user can create, delete, and update the collection by adding/removing metadata to/from the collection.

### BRIEF DESCRIPTION OF THE FIGURES

FIG. 1 illustrates an ETL and data warehouse system in accordance with an embodiment of the present invention.

FIG. 2 illustrates a metadata warehouse in accordance with an embodiment of the present invention.

FIG. 3 presents a flowchart illustrating the process of securing metadata in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein.

The data structures and code described in this detailed description are typically stored on a computer readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Data Warehouse System

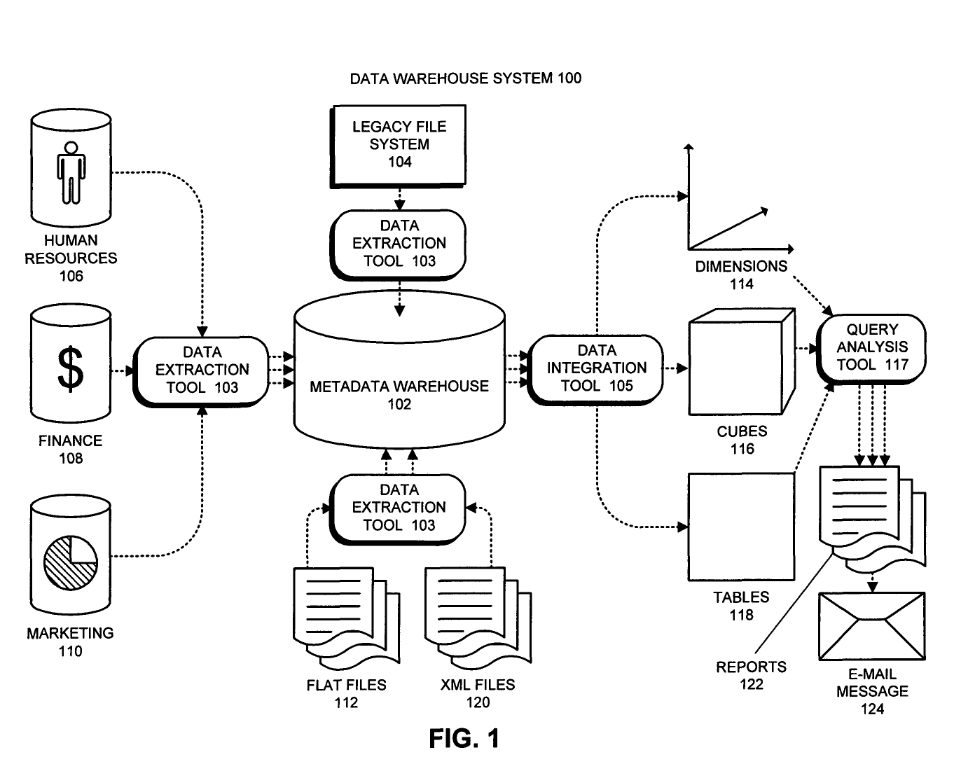

FIG. 1 illustrates a data warehouse system 100 in accordance with an embodiment of the present invention. Data warehouse system 100 includes metadata warehouse 102, data extraction tool 103, legacy file system 104, data integration tool 105, human resources database 106, finance database 108, marketing database 110, flat files 112, dimensions 114, cubes 116, query analysis tool 117, tables 118, extensible markup language (XML) files 120, reports 122, and e-mail message 124. Note that human resources database 106, finance database 108, marketing database 110, flat files 112, and XML files 120 are exemplary data sources.

Legacy file system 104, human resources database 106, finances database 108, marketing database 110, flat files 112, and XML files 120 comprise the source data storage elements of data warehouse system 100. Note that data warehouse system 100 can include more or fewer source data storage elements than are shown in FIG. 1. Source data is loaded to metadata warehouse 102 through data extraction tool 103. Dimensions 114, cubes 116, and tables 118 are the target data storage elements. After source data has been loaded, the source data is integrated by using transformation and mapping metadata. Reports 122 provide analytical data for specific queries based on the integrated data generated by analytical tool 117. Note that data warehouse system 100 can also include more or fewer target data storage elements, analytical tools, and outputs than are shown in FIG. 1. E-mail message 124 represents a message generated by data warehouse system 100, perhaps automatically, to inform an individual of the availability of a report or to send the report to an individual.

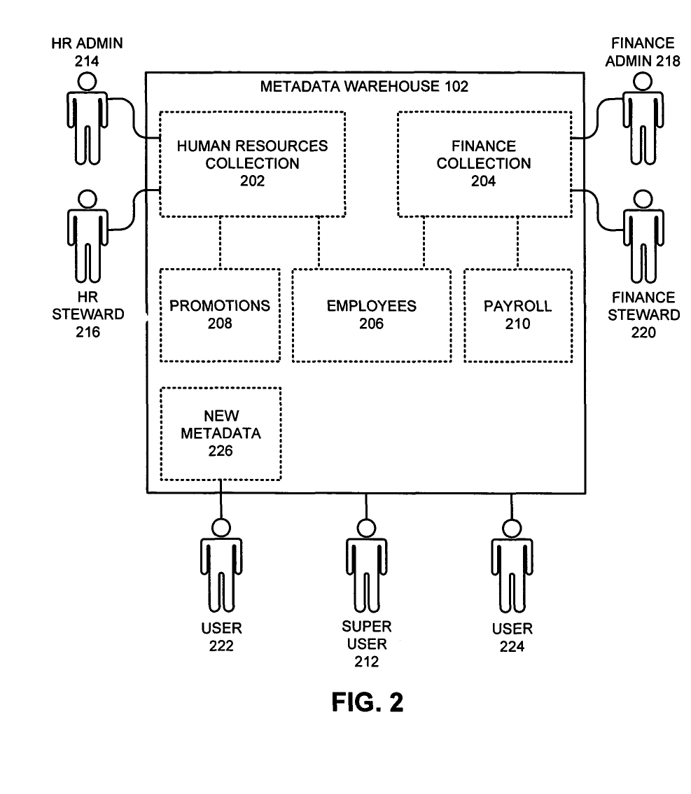

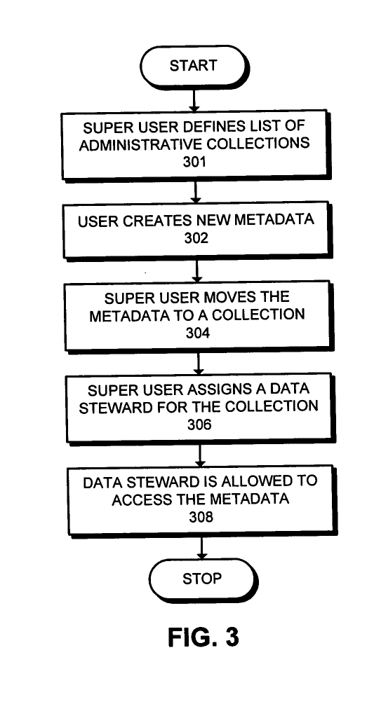

The structure of the various files, databases, analytical tools, reports, and messages is encapsulated in metadata related to data warehouse system 100. Metadata also includes the procedures, transformations, and maps related to database 100. This metadata is stored in metadata warehouse 102 as is described below in conjunction with FIGS. 2 and 3.

Metadata Warehouse

FIG. 2 illustrates a metadata warehouse 102 in accordance with an embodiment of the present invention. Metadata warehouse 102 includes human resources collection 202, finance collection 204, and metadata objects, such as promotions 208, employees 206, payroll 210, and new metadata 226.

Super user 212 organizes the metadata within metadata warehouse 102 into various collections, such as human resources collection 202 and finance collection 204. Note that while FIG. 2 illustrates collections organized along functional lines of an enterprise, the collections can be organized along any desired lines, such as along geographical lines. Note also that any number of collections can be created as desired for a given system.

A given collection includes pointers or shortcuts to metadata that is related to that collection. For example, human resources collection 202 points to promotions 208 and employees 206. Promotions 208 may include metadata related to a pending promotion, while employees 206 may include metadata related to all employees of an organization. Finance collection 204 points to employees 206 and payroll 210. Payroll 210 may include metadata related to the payroll system of the organization. Note that employees 206 is included in both human resources collection 202 and finance collection 204. This dual membership of employees 206 is necessary because both human resources and finance need access to the employee records and the metadata that describes the employee records.

Super user 212 also controls access to the various collections. In FIG. 2, super user 212 has assigned HR admin 214 to administer human resources collection 202 and finance admin 218 to administer finance collection 204. This makes HR admin 214 and finance admin 218 responsible for adding metadata to human resources collection 202 and finance collection 204, respectively.

Super user 212 has also assigned HR steward 216 and finance steward 220. HR steward 216 and finance steward 220 can edit and delete metadata within human resources collection 202 and finance admin 218, respectively. A steward, for example finance steward 220, can include more than one individual. Also, a given individual can be identified as a steward for more than one collection.

Any user, for example user 222, can create metadata for the data warehouse system as shown by new metadata 226. User 222 is the only person that can change new metadata 226 until super user 212 assigns new metadata 226 to a collection. After new metadata 226 has been assigned to a collection, the data steward for that collection can then edit and/or delete the new metadata 226. If user 222 is not a data steward for collection where new metadata 226 has been placed, user 222 can no longer edit new metadata 226. Moreover, user 224 cannot edit or delete any metadata of any collection within metadata warehouse 102 unless super user 212 assigns user 224 as a data steward for one or more collections.

Securing Metadata

FIG. 3 presents a flowchart illustrating the process of securing metadata in accordance with an embodiment of the present invention. The system starts when the super user defines a list of administrative collections (step 301). Next, a user creates new metadata (step 302). At this point, the user has complete control over this new metadata. The super user then moves the metadata to a collection (step 304). Next, the super user assigns a data steward for the collection (step 306). When the super user assigns the new metadata to a collection, the user may not have control over the new metadata unless the user is also a data steward for the collection. Note that the process of assigning a data steward may have been accomplished prior to the user creating the new metadata, and that more than one data steward may have been previously assigned to the collection. Finally, the data steward is allowed access to the metadata (step 308). A data steward can create objects in a folder in a collection. These objects are automatically registered in the collection; this behavior eases the administration of the collection.

The foregoing descriptions of embodiments of the present invention have been presented for purposes of illustration and description only. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

1. A method for facilitating data stewardship for metadata in a data warehouse system, comprising:
allowing a user to create metadata for use in the data warehouse system;
allowing a super user to move the metadata into and out of a collection;
allowing the super user to assign a data steward for the collection; and
allowing the data steward to manipulate the metadata in the collection.

2. The method of claim 1, further comprising allowing a collection administrator to move metadata into and out of the collection.

3. The method of claim 1, wherein the data steward includes more than one individual.

4. The method of claim 1, wherein manipulating the metadata includes editing and deleting the metadata.

5. The method of claim 1, wherein the collection is related to a specified domain.

6. The method of claim 1, wherein the data steward can be a data steward for more than one collection.

7. The method of claim 1, wherein the super user has access to the metadata within a plurality of collections.

8. The method of claim 1, wherein the metadata can include data descriptions.

9. The method of claim 1, wherein the metadata can include procedures related to the data warehouse system.

10. The method of claim 1, further comprising:
allowing the user to create a new metadata; and
allowing the user to request that the new metadata be moved to the collection.

11. The method of claim 1, further comprising allowing the user to manipulate metadata that the user owns and that does not belong to the collection.

12. The method of claim 1, further comprising allowing the data steward to create metadata within a folder in the collection, wherein creating metadata within the folder automatically causes the metadata to be added to the collection.

13. The method of claim 1,
wherein only the super user can create/delete a collection; and
wherein only the super user can update the collection by moving metadata to/from the collection.

14. A computer-readable storage medium storing instructions that when executed by a computer cause the computer to perform a method for facilitating data stewardship for metadata in a data warehouse system, the method comprising:
allowing a user to create metadata for use in the data warehouse system;
allowing a super user to move the metadata into and out of a collection;
allowing the super user to assign a data steward for the collection; and
allowing the data steward to manipulate the metadata in the collection.

15. The computer-readable storage medium of claim 14, the method further comprising allowing a collection administrator to move metadata into and out of the collection.

16. The computer-readable storage medium of claim 14, wherein the data steward includes more than one individual.

17. The computer-readable storage medium of claim 14, wherein manipulating the metadata includes editing and deleting the metadata.

18. The computer-readable storage medium of claim 14, wherein the collection is related to a specified domain.

19. The computer-readable storage medium of claim 14, wherein the data steward can be a data steward for more than one collection.

20. The computer-readable storage medium of claim 14, wherein the super user has access to the metadata within a plurality of collections.

21. The computer-readable storage medium of claim 14, wherein more than one data steward can be a data steward for a specified collection.

22. The computer-readable storage medium of claim 14, wherein the metadata can include procedures related to the data warehouse system.

23. The computer-readable storage medium of claim 14, the method further comprising:
allowing the user to create a new metadata; and
allowing the user to request that the new metadata be moved to the collection.

24. The computer-readable storage medium of claim 14, the method further comprising allowing the user to manipulate metadata that the user owns and that does not belong to the collection.

25. The computer-readable storage medium of claim 14, the method further comprising allowing the data steward to create metadata within a folder in the collection, wherein creating metadata within the folder automatically causes the metadata to be added to the collection.

26. The computer-readable storage medium of claim 14,
wherein only the super user can create/delete a collection; and
wherein only the super user can update the collection by moving metadata to/from the collection.

27. An apparatus for facilitating data stewardship for metadata in a data warehouse system, comprising:
a creating mechanism configured to allow a user to create metadata for use in the data warehouse system;
a moving mechanism configured to allow a super user to move the metadata into and out of a collection;
an assigning mechanism configured to allow the super user to assign a data steward for the collection; and
a manipulating mechanism configured to allow the data steward to manipulate the metadata in the collection.

28. The apparatus of claim 27, wherein the moving mechanism is further configured to allow a collection administrator to move metadata into and out of the collection.

29. The apparatus of claim 27, wherein the data steward includes more than one individual.

30. The apparatus of claim 27, wherein manipulating the metadata includes editing and deleting the metadata.

31. The apparatus of claim 27, wherein the collection is related to a specified domain.

32. The apparatus of claim 27, wherein the data steward can be a data steward for more than one collection.

33. The apparatus of claim 27, wherein the super user has access to the metadata within a plurality of collections.

34. The apparatus of claim 27, wherein the metadata can include data descriptions.

35. The apparatus of claim 27, wherein the metadata can include procedures related to the data warehouse system.

36. The apparatus of claim 27, further comprising:
a metadata creating mechanism configured to allow the user to create a new metadata; and
a requesting mechanism configured to allow the user to request that the new metadata be moved to the collection.

37. The apparatus of claim 27, wherein the manipulating mechanism is further configured to allow the user to manipulate metadata that the user owns and that does not belong to the collection.

38. The apparatus of claim 27, wherein the creating mechanism is further configured to allow the data steward to create metadata within a folder in the collection, wherein creating metadata within the folder automatically causes the metadata to be added to the collection.

39. The apparatus of claim 27,
wherein only the super user can create/delete a collection; and
wherein only the super user can update the collection by moving metadata to/from the collection.
